(19) United States
(12) Patent Application Publication
(10) Pub. No.: US 2016/0125360 A1
(43) Pub. Date: May 5, 2016

(54) CANDIDATE PIPELINE BUILDER

(71) Applicant: ORACLE INTERNATIONAL CORPORATION, REDWOOD SHORES, CA (US)

(72) Inventors: BARKAT ALI, FREMONT, CA (US); JOHN CULLEN, SANTA MONICA, CA (US)

(73) Assignee: ORACLE INTERNATIONAL CORPORATION, REDWOOD SHORES, CA (US)

(21) Appl. No.: 14/532,078

(22) Filed: Nov. 4, 2014

(51) Int. Cl. G06Q 10/10

(52) U.S. Cl. CPC G06Q 10/1053

(57) ABSTRACT

Embodiments of the invention provide for identifying candidates for an open position. More specifically, embodiments provide for matching, comparing and sorting candidates based on skill set, job title, education, and/or other attributes described in a candidate profile with a requisition in a recruiting application. Embodiments of the present invention can build candidate pools for current or future openings without manual intervention. Embodiments can segment candidate profiles, e.g., which can be built from collected resumes, based on skill set, education, job title match, and/or other criteria. Matches can be found between these profiles and a set of requirements for a position based on one or more searches including but not limited to a keyword search, a synonym replacement search, a distance matching search, etc. Results of these searches can be weighted and combined into an ordered candidate list or pipeline presented to the recruiter or other user for review.

### BACKGROUND OF THE INVENTION

Embodiments of the present invention relate generally to methods and systems for identifying candidates for an open position and more particularly to an automated way to match, compare and sort candidates based on skill set, job title, education, and/or other attributes described in a candidate profile with a requisition in a recruiting application.

A Human Capital Management (HCM) application is a type of enterprise application which performs a variety of different functions related to the generation and management of information related to employees and other persons related to a business. For example, an HCM application can generate and maintain records for an employee which can contain information related to payroll, performance reviews, training, etc. Another function commonly performed by and HCM application is recruiting. Generally speaking, these functions include the generation of requisitions for open positions and the collection of resumes directed to those positions. Once collected, these resumes can be reviewed by a recruiter or manager to determine which candidates may be best suited for the requirements of the open position. In some cases, depending upon the nature of the open position, a very large number of resumes may be collected. Screening and sorting the best candidates from a huge pile of resumes is a challenging and tedious job for a recruiter. Matching candidate's resume with the requirements of an open position is time consuming and frustrating. Hence, there is a need for improved methods and systems for identifying candidates for an open position.

### BRIEF SUMMARY OF THE INVENTION

Embodiments of the invention provide systems and methods for identifying candidates for an open position. According to one embodiment, identifying candidates for an open position can comprise receiving a plurality of requirements for an open position and generating a requisition for the open position based on the received plurality of requirements. Resumes can be collected from a plurality of candidates for the open position and a candidate profile can be generated for each candidate based on the collected resumes. A search can then be performed on the generated candidate profiles using the generated requisition.

According to one embodiment, performing the search on the generated candidate profiles using the generated requisition can comprise reading from the requisition a plurality of requirements for the open position and segregating the plurality of requirements into a plurality of different search criteria. For example, the plurality of different search criteria can comprise one or more job title criteria, one or more education criteria, and one or more skills criteria. Performing the search on the generated candidate profiles using the generated requisition can comprise performing a keyword search on the generated candidate profiles using the plurality of different search criteria and weighting results of performing the keyword search. Additionally or alternatively, performing the search on the generated candidate profiles using the generated requisition can comprise performing a synonym replacement search on the generated candidate profiles using the plurality of different search criteria and weighting results of performing the synonym replacement search. Additionally or alternatively, performing the search on the generated candidate profiles using the generated requisition can comprise performing a distance matching search on the generated candidate profiles using the plurality of different search criteria and weighting results of performing the distance matching search. In some cases, a weight applied to each of the results of performing the keyword search, the results of performing the synonym replacement search, and the results of performing the distance matching search can be definable by a user.

The weighted results of performing the keyword search, the weighted results of performing the synonym replacement search, and weighted results of performing the distance matching search can be combined and the combined weighted results for the plurality of candidates can be scored. A ranked candidate list can be generated based on results of performing the search. A ranking in the ranked candidate list can be based on a score for the combined weighted results. According to one embodiment, the ranking for each of the plurality of candidates in the candidate list can be adjustable by a user.

### BRIEF DESCRIPTION OF THE DRAWINGS

FIG. 1 is a block diagram illustrating components of an exemplary distributed system in which various embodiments of the present invention may be implemented.

FIG. 2 is a block diagram illustrating components of a system environment by which services provided by embodiments of the present invention may be offered as cloud services.

FIG. 3 is a block diagram illustrating an exemplary computer system in which embodiments of the present invention may be implemented.

FIG. 4 is a block diagram illustrating, at a high-level, functional components of a system for providing a candidate pipeline according to one embodiment of the present invention.

FIG. 5 is a flowchart illustrating a process for providing a candidate pipeline according to one embodiment of the present invention.

FIG. 6 is a flowchart illustrating an exemplary process for searching a set of candidate profiles using a requisition for an open position according to one embodiment of the present invention.

FIG. 7 is a flowchart illustrating additional details of an exemplary process for searching a set of candidate profiles using a requisition for an open position according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for identifying candidates for an open position. More specifically, embodiments provide an automated way to match, compare and sort candidates based on skill set, job title, education, and/or other attributes described in a candidate profile with a requisition in a recruiting application. Embodiments of the present invention can build candidate pools for current or future openings without manual intervention. Embodiments can segment candidate profiles, e.g., which can be built from collected resumes, based on skill set, education, job title match, and/or other criteria. Matches can be found between these profiles and a set of requirements for a position based on one or more searches including but not limited to a keyword search, a synonym replacement search, a distance matching search, etc. Results of these searches can be weighted and combined into an ordered candidate list or pipeline presented to the recruiter or other user for review. As a result, a recruiter can be given a starting point to screen the candidates instead of needing to scrutinize all resumes for a job opening. According to one embodiment, the recruiter or other user can have an option to change the match score based on manual intervention if needed. Various additional details of embodiments of the present invention will be described below with reference to the figures.

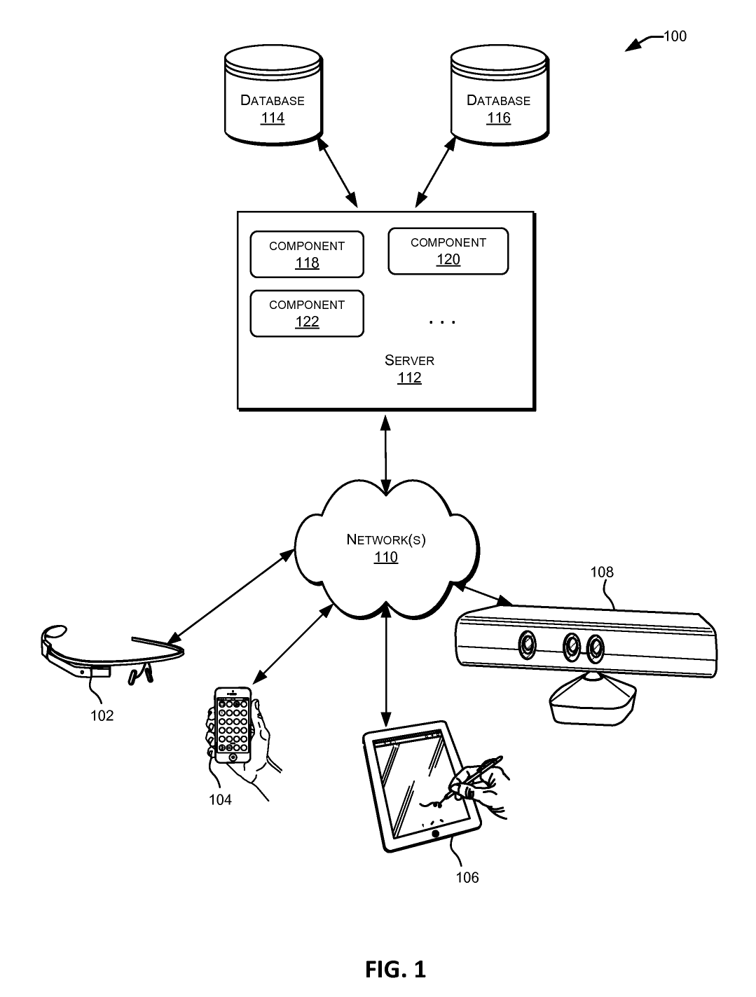

FIG. 1 is a block diagram illustrating components of an exemplary distributed system in which various embodiments of the present invention may be implemented. In the illustrated embodiment, distributed system 100 includes one or more client computing devices 102, 104, 106, and 108, which are configured to execute and operate a client application such as a web browser, proprietary client (e.g., Oracle Forms), or the like over one or more network(s) 110. Server 112 may be communicatively coupled with remote client computing devices 102, 104, 106, and 108 via network 110.

In various embodiments, server 112 may be adapted to run one or more services or software applications provided by one or more of the components of the system. In some embodiments, these services may be offered as web-based or cloud services or under a Software as a Service (SaaS) model to the users of client computing devices 102, 104, 106, and/or 108. Users operating client computing devices 102, 104, 106, and/or 108 may in turn utilize one or more client applications to interact with server 112 to utilize the services provided by these components.

In the configuration depicted in the figure, the software components 118, 120 and 122 of system 100 are shown as being implemented on server 112. In other embodiments, one or more of the components of system 100 and/or the services provided by these components may also be implemented by one or more of the client computing devices 102, 104, 106, and/or 108. Users operating the client computing devices may then utilize one or more client applications to use the services provided by these components. These components may be implemented in hardware, firmware, software, or combinations thereof. It should be appreciated that various different system configurations are possible, which may be different from distributed system 100. The embodiment shown in the figure is thus one example of a distributed system for implementing an embodiment system and is not intended to be limiting.

Client computing devices 102, 104, 106, and/or 108 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 102, 104, 106, and 108 may be any other electronic device, such as a thin-client computer, an Internet-enabled gaming system (e.g., a Microsoft Xbox gaming console with or without a Kinect® gesture input device), and/or a personal messaging device, capable of communicating over network(s) 110.

Although exemplary distributed system 100 is shown with four client computing devices, any number of client computing devices may be supported. Other devices, such as devices with sensors, etc., may interact with server 112.

Network(s) 110 in distributed system 100 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 110 can be a local area network (LAN), such as one based on Ethernet, Token-Ring and/or the like. Network(s) 110 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 112 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 112 may be adapted to run one or more services or software applications described in the foregoing disclosure. For example, server 112 may correspond to a server for performing processing described above according to an embodiment of the present disclosure.

Server 112 may run an operating system including any of those discussed above, as well as any commercially available server operating system. Server 112 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 112 may include one or more applications to analyze and consolidate data feeds and/or event updates received from users of client computing devices 102, 104, 106, and 108. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 112 may also include one or more applications to display the data feeds and/or real-time events via one or more display devices of client computing devices 102, 104, 106, and 108.

Distributed system 100 may also include one or more databases 114 and 116. Databases 114 and 116 may reside in a variety of locations. By way of example, one or more of databases 114 and 116 may reside on a non-transitory storage medium local to (and/or resident in) server 112. Alternatively, databases 114 and 116 may be remote from server 112 and in communication with server 112 via a network-based or dedicated connection. In one set of embodiments, databases 114 and 116 may reside in a storage-area network (SAN). Similarly, any necessary files for performing the functions attributed to server 112 may be stored locally on server 112 and/or remotely, as appropriate. In one set of embodiments, databases 114 and 116 may include relational and/or non-relational databases, such as databases provided by Oracle, that are adapted to store, update, and retrieve data in response to SQL-formatted commands.

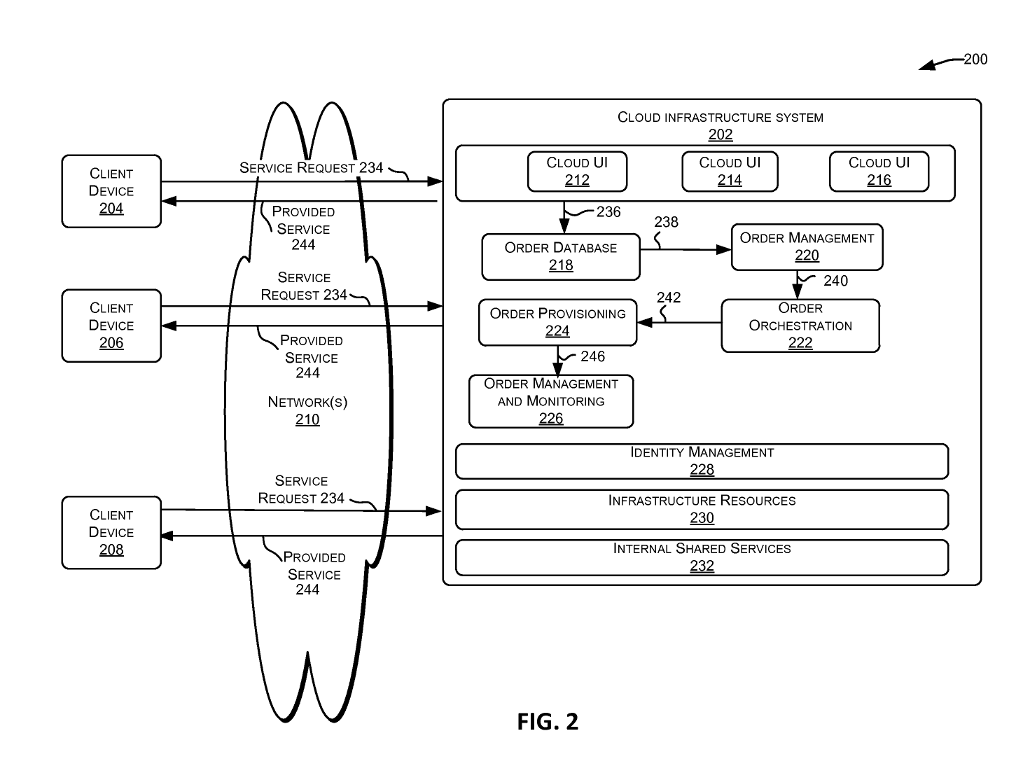

FIG. 2 is a block diagram illustrating components of a system environment by which services provided by embodiments of the present invention may be offered as cloud services. In the illustrated embodiment, system environment 200 includes one or more client computing devices 204, 206, and 208 that may be used by users to interact with a cloud infrastructure system 202 that provides cloud services. The client computing devices may be configured to operate a client application such as a web browser, a proprietary client application (e.g., Oracle Forms), or some other application, which may be used by a user of the client computing device to interact with cloud infrastructure system 202 to use services provided by cloud infrastructure system 202.

It should be appreciated that cloud infrastructure system 202 depicted in the figure may have other components than those depicted. Further, the embodiment shown in the figure is only one example of a cloud infrastructure system that may incorporate an embodiment of the invention. In some other embodiments, cloud infrastructure system 202 may have more or fewer components than shown in the figure, may combine two or more components, or may have a different configuration or arrangement of components.

Client computing devices 204, 206, and 208 may be devices similar to those described above for 102, 104, 106, and 108.

Although exemplary system environment 200 is shown with three client computing devices, any number of client computing devices may be supported. Other devices such as devices with sensors, etc. may interact with cloud infrastructure system 202.

Network(s) 210 may facilitate communications and exchange of data between clients 204, 206, and 208 and cloud infrastructure system 202. Each network may be any type of network familiar to those skilled in the art that can support data communications using any of a variety of commercially-available protocols, including those described above for network(s) 110.

Cloud infrastructure system 202 may comprise one or more computers and/or servers that may include those described above for server 112.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 202 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 202 may be adapted to automatically provision, manage and track a customer's subscription to services offered by cloud infrastructure system 202. Cloud infrastructure system 202 may provide the cloud services via different deployment models. For example, services may be provided under a public cloud model in which cloud infrastructure system 202 is owned by an organization selling cloud services (e.g., owned by Oracle) and the services are made available to the general public or different industry enterprises. As another example, services may be provided under a private cloud model in which cloud infrastructure system 202 is operated solely for a single organization and may provide services for one or more entities within the organization. The cloud services may also be provided under a community cloud model in which cloud infrastructure system 202 and the services provided by cloud infrastructure system 202 are shared by several organizations in a related community. The cloud services may also be provided under a hybrid cloud model, which is a combination of two or more different models.

In some embodiments, the services provided by cloud infrastructure system 202 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 202. Cloud infrastructure system 202 then performs processing to provide the services in the customer's subscription order.

In some embodiments, the services provided by cloud infrastructure system 202 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 202 may also include infrastructure resources 230 for providing the resources used to provide various services to customers of the cloud infrastructure system. In one embodiment, infrastructure resources 230 may include pre-integrated and optimized combinations of hardware, such as servers, storage, and networking resources to execute the services provided by the PaaS platform and the SaaS platform.

In some embodiments, resources in cloud infrastructure system 202 may be shared by multiple users and dynamically re-allocated per demand. Additionally, resources may be allocated to users in different time zones. For example, cloud infrastructure system 230 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 232 may be provided that are shared by different components or modules of cloud infrastructure system 202 and by the services provided by cloud infrastructure system 202. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 202 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 202, and the like.

In one embodiment, as depicted in the figure, cloud management functionality may be provided by one or more modules, such as an order management module 220, an order orchestration module 222, an order provisioning module 224, an order management and monitoring module 226, and an identity management module 228. These modules may include or be provided using one or more computers and/or servers, which may be general purpose computers, specialized server computers, server farms, server clusters, or any other appropriate arrangement and/or combination.

In exemplary operation 234, a customer using a client device, such as client device 204, 206 or 208, may interact with cloud infrastructure system 202 by requesting one or more services provided by cloud infrastructure system 202 and placing an order for a subscription for one or more services offered by cloud infrastructure system 202. In certain embodiments, the customer may access a cloud User Interface (UI), cloud UI 212, cloud UI 214 and/or cloud UI 216 and place a subscription order via these UIs. The order information received by cloud infrastructure system 202 in response to the customer placing an order may include information identifying the customer and one or more services offered by the cloud infrastructure system 202 that the customer intends to subscribe to.

After an order has been placed by the customer, the order information is received via the cloud UIs, 212, 214 and/or 216.

At operation 236, the order is stored in order database 218. Order database 218 can be one of several databases operated by cloud infrastructure system 218 and operated in conjunction with other system elements.

At operation 238, the order information is forwarded to an order management module 220. In some instances, order management module 220 may be configured to perform billing and accounting functions related to the order, such as verifying the order, and upon verification, booking the order.

At operation 240, information regarding the order is communicated to an order orchestration module 222. Order orchestration module 222 may utilize the order information to orchestrate the provisioning of services and resources for the order placed by the customer. In some instances, order orchestration module 222 may orchestrate the provisioning of resources to support the subscribed services using the services of order provisioning module 224.

In certain embodiments, order orchestration module 222 enables the management of business processes associated with each order and applies business logic to determine whether an order should proceed to provisioning. At operation 242, upon receiving an order for a new subscription, order orchestration module 222 sends a request to order provisioning module 224 to allocate resources and configure those resources needed to fulfill the subscription order. Order provisioning module 224 enables the allocation of resources for the services ordered by the customer. Order provisioning module 224 provides a level of abstraction between the cloud services provided by cloud infrastructure system 200 and the physical implementation layer that is used to provision the resources for providing the requested services. Order orchestration module 222 may thus be isolated from implementation details, such as whether or not services and resources are actually provisioned on the fly or pre-provisioned and only allocated/assigned upon request.

At operation 244, once the services and resources are provisioned, a notification of the provided service may be sent to customers on client devices 204, 206 and/or 208 by order provisioning module 224 of cloud infrastructure system 202.

At operation 246, the customer's subscription order may be managed and tracked by an order management and monitoring module 226. In some instances, order management and monitoring module 226 may be configured to collect usage statistics for the services in the subscription order, such as the amount of storage used, the amount data transferred, the number of users, and the amount of system up time and system down time.

In certain embodiments, cloud infrastructure system 200 may include an identity management module 228. Identity management module 228 may be configured to provide identity services, such as access management and authorization services in cloud infrastructure system 200. In some embodiments, identity management module 228 may control information about customers who wish to utilize the services provided by cloud infrastructure system 202. Such information can include information that authenticates the identities of such customers and information that describes which actions those customers are authorized to perform relative to various system resources (e.g., files, directories, applications, communication ports, memory segments, etc.) Identity management module 228 may also include the management of descriptive information about each customer and about how and by whom that descriptive information can be accessed and modified.

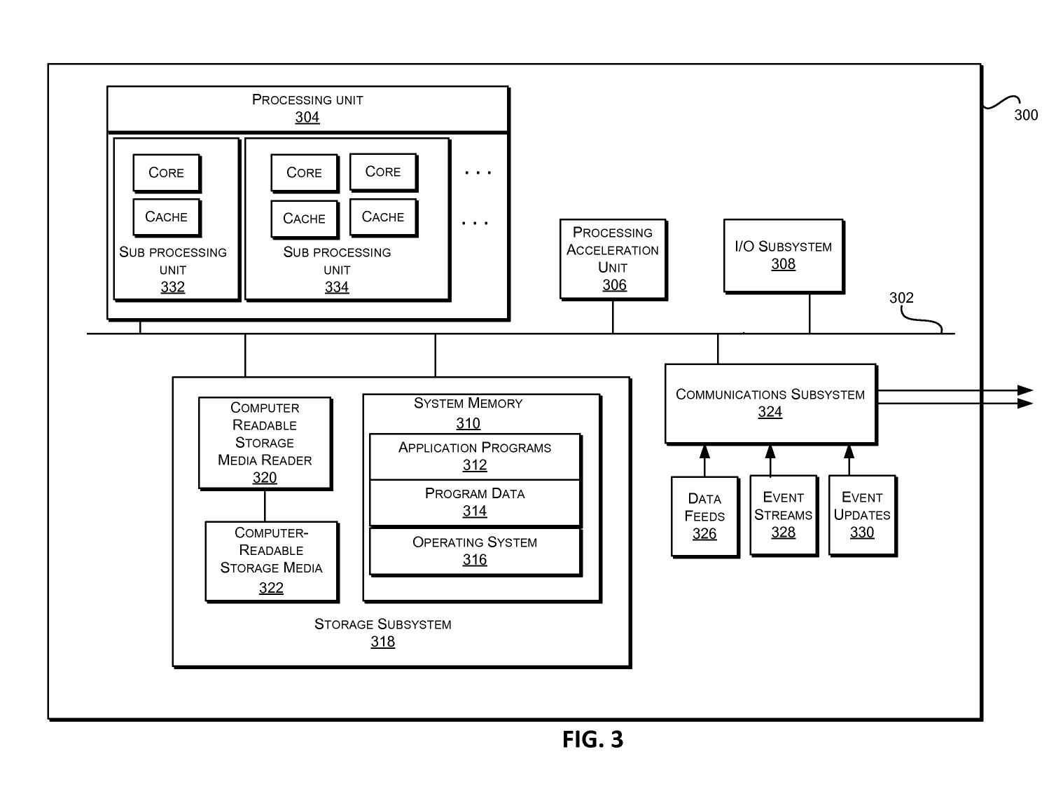

FIG. 3 is a block diagram illustrating an exemplary computer system in which embodiments of the present invention may be implemented. The system 300 may be used to implement any of the computer systems described above. As shown in the figure, computer system 300 includes a processing unit 304 that communicates with a number of peripheral subsystems via a bus subsystem 302. These peripheral subsystems may include a processing acceleration unit 306, an I/O subsystem 308, a storage subsystem 318 and a communications subsystem 324. Storage subsystem 318 includes tangible computer-readable storage media 322 and a system memory 310.

Bus subsystem 302 provides a mechanism for letting the various components and subsystems of computer system 300 communicate with each other as intended. Although bus subsystem 302 is shown schematically as a single bus, alternative embodiments of the bus subsystem may utilize multiple buses. Bus subsystem 302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 304, which can be implemented as one or more integrated circuits (e.g., a conventional microprocessor or microcontroller), controls the operation of computer system 300. One or more processors may be included in processing unit 304. These processors may include single core or multicore processors. In certain embodiments, processing unit 304 may be implemented as one or more independent processing units 332 and/or 334 with single or multicore processors included in each processing unit. In other embodiments, processing unit 304 may also be implemented as a quad-core processing unit formed by integrating two dual-core processors into a single chip.

In various embodiments, processing unit 304 can execute a variety of programs in response to program code and can maintain multiple concurrently executing programs or processes. At any given time, some or all of the program code to be executed can be resident in processor(s) 304 and/or in storage subsystem 318. Through suitable programming, processor(s) 304 can provide various functionalities described above. Computer system 300 may additionally include a processing acceleration unit 306, which can include a digital signal processor (DSP), a special-purpose processor, and/or the like.

I/O subsystem 308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 300 may comprise a storage subsystem 318 that comprises software elements, shown as being currently located within a system memory 310. System memory 310 may store program instructions that are loadable and executable on processing unit 304, as well as data generated during the execution of these programs.

Depending on the configuration and type of computer system 300, system memory 310 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 304. In some implementations, system memory 310 may include multiple different types of memory, such as static random access memory (SRAM) or dynamic random access memory (DRAM). In some implementations, a basic input/output system (BIOS), containing the basic routines that help to transfer information between elements within computer system 300, such as during start-up, may typically be stored in the ROM. By way of example, and not limitation, system memory 310 also illustrates application programs 312, which may include client applications, Web browsers, mid-tier applications, relational database management systems (RDBMS), etc., program data 314, and an operating system 316. By way of example, operating system 316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 318 may also provide a tangible computer-readable storage medium for storing the basic programming and data constructs that provide the functionality of some embodiments. Software (programs, code modules, instructions) that when executed by a processor provide the functionality described above may be stored in storage subsystem 318. These software modules or instructions may be executed by processing unit 304. Storage subsystem 318 may also provide a repository for storing data used in accordance with the present invention.

Storage subsystem 300 may also include a computer-readable storage media reader 320 that can further be connected to computer-readable storage media 322. Together and, optionally, in combination with system memory 310, computer-readable storage media 322 may comprehensively represent remote, local, fixed, and/or removable storage devices plus storage media for temporarily and/or more permanently containing, storing, transmitting, and retrieving computer-readable information.

Computer-readable storage media 322 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 300.

By way of example, computer-readable storage media 322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 322 may include, but is not limited to, Zip® drives, flash memory cards, universal serial bus (USB) flash drives, secure digital (SD) cards, DVD disks, digital video tape, and the like. Computer-readable storage media 322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 300.

Communications subsystem 324 provides an interface to other computer systems and networks. Communications subsystem 324 serves as an interface for receiving data from and transmitting data to other systems from computer system 300. For example, communications subsystem 324 may enable computer system 300 to connect to one or more devices via the Internet. In some embodiments communications subsystem 324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 324 can provide wired network connectivity (e.g., Ethernet) in addition to or instead of a wireless interface.

In some embodiments, communications subsystem 324 may also receive input communication in the form of structured and/or unstructured data feeds 326, event streams 328, event updates 330, and the like on behalf of one or more users who may use computer system 300.

By way of example, communications subsystem 324 may be configured to receive data feeds 326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 324 may also be configured to receive data in the form of continuous data streams, which may include event streams 328 of real-time events and/or event updates 330, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 324 may also be configured to output the structured and/or unstructured data feeds 326, event streams 328, event updates 330, and the like to one or more databases that may be in communication with one or more streaming data source computers coupled to computer system 300.

Computer system 300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

As introduced above, embodiments of the invention can provide systems and methods for identifying candidates for an open position. More specifically, embodiments provide an automated way to match, compare and sort candidates based on skill set, job title, education, and/or other attributes described in a candidate profile with a requisition in a recruiting application. Embodiments of the present invention can build candidate pools for current or future openings without manual intervention. Embodiments can segment candidate profiles, e.g., which can be built from collected resumes, based on skill set, education, job title match, and/or other criteria. Matches can be found between these profiles and a set of requirements for a position based on one or more searches including but not limited to a keyword search, a synonym replacement search, a distance matching search, etc. Results of these searches can be weighted and combined into an ordered candidate list or pipeline presented to the recruiter or other user for review. As a result, a recruiter can be given a starting point to screen the candidates instead of needing to scrutinize all resumes for a job opening.

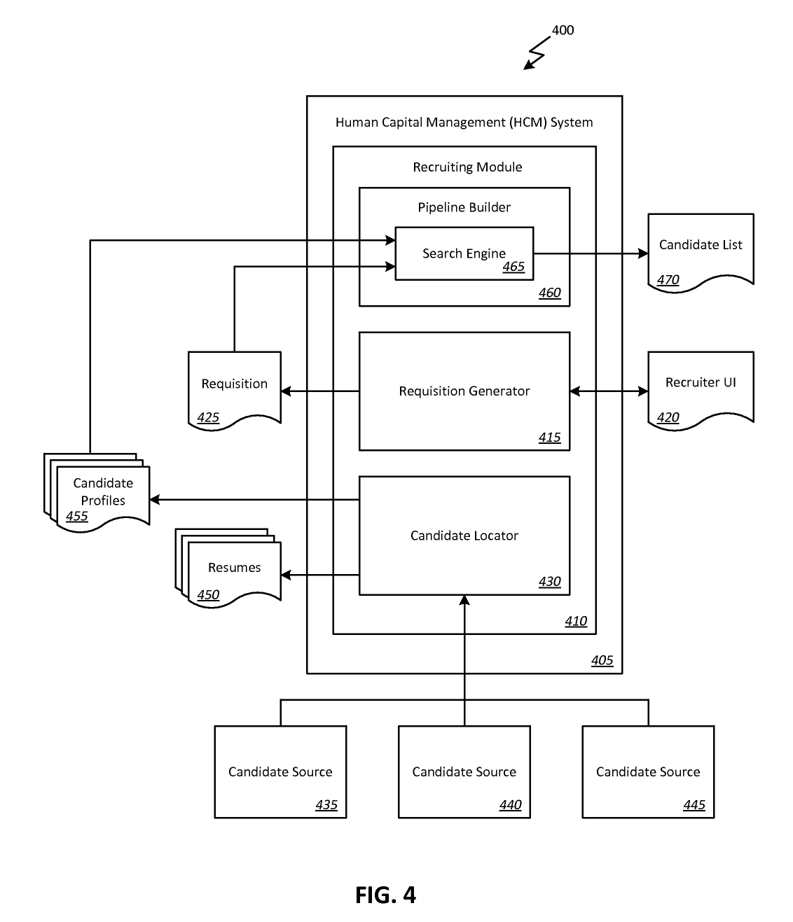

FIG. 4 is a block diagram illustrating, at a high-level, functional components of a system for providing a candidate pipeline according to one embodiment of the present invention. As illustrated in this example, the system 400 can include a Human Capital Management (HCM) system 405. This system 405 can comprise any of the servers or other computing devices described above executing an HCM application. Such an application can include a recruiting module 410 also executed by the HCM system 405. Generally speaking, the recruiting module 410 can provide a recruiter user interface 420 such as a set of web pages or other graphical or textual interface through which a recruiter, manager, or other user can identify an open position and define a set of requirements for eligible candidates for that position. For example, a user can indicate through the recruiter user interface 420 that there is a need for an entry level programmer with a Bachelor of Science degree in computer science and experience with C++ and Java programming. Once approved by the appropriate managers, a requisition generator 415 of the recruiting module 410 can generate a formal requisition 425 indicating the existence of the open position and defining the requirements for that position as collected through the recruiter user interface 420.

The recruiting module 410 can also include a candidate locator module 430. Generally speaking, the requisition 425 can be made available by the requisition generator 415 and/or other element of the HCM system 405 internally throughout the enterprise and/or externally through any number of channels to make the existence of the open position known. For example, the requisition 425 or information from the requisition 425 can be made available through any number of internal and/or external web pages, emails, instant messages, news feeds, etc. The candidate locator 430 can then receive and save a set of resumes 450 from any number of candidate sources 435, 440, and 445 including but not limited to internal users of the HCM system 405, external users submitting resumes through an externally or publicly available web page provided by the candidate locator 430 or other element of the HCM system 405, through emails to addresses monitored by the candidate locator 430, through third-party jobs boards or other publically available sources reposting the information, etc.

Once the resumes 450 have been collected, the candidate locator 430 or other element of the recruiting module 410 can generate a candidate profile 455 for each of the candidates from the candidates' resumes 450. Generally speaking, the candidate locator 430 can parse resume each and extract information and build a candidate profile 455 based on keyword identification, semantic analysis, and other methods known in the art. The attributes of these profiles 455 can represent information including but not limited to the candidate's education, professional certifications, work history (e.g., titles of positions held, possibly with dates and/or duration for each), other indications of skills held, positions sought, etc.

According to one embodiment, the recruiting module 410 can also include a pipeline builder 460 that can use the generated candidate profiles 455 and the requisition 425 to identify candidates within a potentially large pool that are good matches for the open position. More specifically, the pipeline builder 460 can segment the candidate profile information, for example, based on skill set, education, job title, and a search engine 465 can be used to identify matches between each of the attributes and the corresponding requirements identified in the requisition. The comparison or search made by the search engine 465 can include a plurality of different searches which can include but are not limited to a keyword search, a distance search algorithm, a synonym substitution and java regular expression matching, etc. A weighting scheme can be applied to any or all of these searches. For example, an exact string match may be given a weight of 100% while a similar string match may be given a weight between 0%-99% based on word distance and/or synonyms. Overall the algorithm used by the search engine 465 can find not only exact matches but also similarities between the requisition 425 and the candidate's profiles 455 and can generated an ordered and scored candidate list 470 which can represent a pipeline of available candidates filtered and sorted by a degree to which they likely match the requirements of the open position.

Stated another way, the system 400 can identify candidates for an open position by receiving through the recruiter user interface 420 and requisition generator 415 a plurality of requirements and other information for an open position. Such requirements and other information can include but are not limited to a job title, educational requirements, skills required, etc. received from a manager or recruiter. A requisition 425 can be generated for the open position by the requisition generator 415 based on the received plurality of requirements. Generally speaking, the requisition 415 can include or otherwise indicate the received requirements and can formally indicate the approval and creation of the open position to be filled.

In response to the requisition 425 and the creation of the open position, resumes 450 can be collected by the candidate locator 430 from a plurality of candidates sources 435. A candidate profile 455 can be generated by the candidate locator 430 for each candidate based on the collected resumes 450. The candidate profiles 455 can comprise a more standardized and formalized, i.e., normalized, representation of the information presented in each received resume. Generation of the candidate profiles 455 can be performed by the candidate locator 430 in any of a variety of different ways as known in the art.

After a set of resumes 450 has been collected and a corresponding set of candidate profiles 455 has been generated, the search engine 465 of the pipeline builder 460 can perform a search on the candidate profiles 455 using the requisition 425. Performing the search can include performing multiple different types of searches of the candidate profiles 455 using the requirements expressed in the requisition 425. Results of these searches can be weighted by the search engine 465 and a ranked candidate list 470 can then be generated by the pipeline builder 460 based on results of performing the search. This list 470 or pipeline can then be presented though a user interface (not shown here) for a manager, recruiter, or other user to review.

More specifically, the pipeline builder 460 can read from the requisition 425 a plurality of requirements for the open position and segregate or separate these requirements into a plurality of different search criteria. Once these separate search criteria are defined, the search engine 465 can perform a search on the generated candidate profiles. In one case, the search can include performing a keyword search on the candidate profiles 455 using the plurality of different search criteria. Results of performing the keyword search can be weighted by the search engine 465 based on the results and one or more weighting factors. Performing the search on the candidate profiles 455 using the requisition 425 can further comprise performing a distance matching search on the candidate profiles 455 using the plurality of different search criteria. Results of performing the distance matching search can also be weighted by the search engine 465 based on the results and one or more weighting factors. Performing the search on the candidate profiles 455 using the requisition 425 can further comprise performing a synonym substitution search on the candidate profiles 455 using the plurality of different search criteria. performing a synonym substitution search can comprise making appropriate synonym substitutions to search criteria and repeating one or both of the keyword search and/or the distance matching search. Results of performing the distance matching search can also be weighted by the search engine 465 based on the results and one or more weighting factors. Additionally or alternatively, other searches may be performed by the search engine 465 and the results of those searches can also be weighted by the search engine 465 based on one or more weighting factors.

The weighted results of performing the keyword search, the weighted results of performing the synonym replacement search, the weighted results of performing the distance matching search, and the weighted results of any other searches performed can then be combined and scored by the pipeline builder 460. A ranking of the results in or the order of the ranked candidate list 470 can be based on a score for the combined weighted results. According to one embodiment, a weight applied by the search engine 465 to each of the results of performing the keyword search, the results of performing the synonym replacement search, and the results of performing the distance matching search can be definable or tunable by a user to influence the results in order to provide better matches. For example, a recruiter or other user can tune up, i.e., more heavily weight, the keyword search while tuning down or decreasing the weight of the synonym replacement and/or distance matching search if results seem to be showing some random or non-applicable results. Conversely, the user might tune up or increase the weighting of the synonym search and decrease the weighting of the keyword search if the results seem to be too narrow. Additionally or alternatively, the ranking for each of plurality of candidates in the candidate list 470 can be adjustable by a user. That is, a user such as a manager or recruiter can move particular candidates up or down in the order if the results do not accurately reflect a proper match. Additional details of exemplary search algorithms will be described further below.

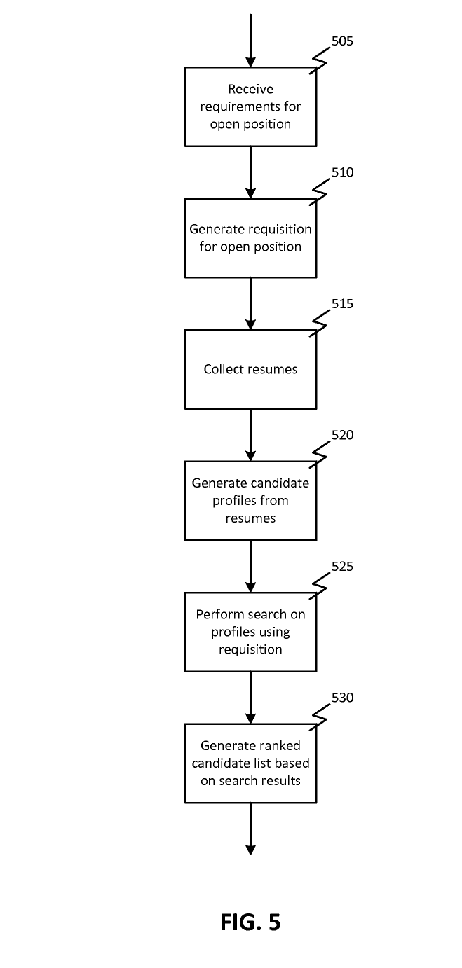

FIG. 5 is a flowchart illustrating a process for providing a candidate pipeline according to one embodiment of the present invention. As illustrated in this example, identifying candidates for an open position can begin with receiving 505 a plurality of requirements and other information for an open position. Such requirements and other information can include but are not limited to a job title, educational requirements, skills required, etc. and can be received though a user interface from a manager or recruiter as described above. A requisition can be generated 510 for the open position based on the received plurality of requirements. Generally speaking, the requisition can include or otherwise indicate the received requirements can formally indicate the approval and creation of the open position to be filled. Generation 510 of the requisition can be performed in any of a variety of different ways as known in the art.

In response to the requisition and the creation of the open position, resumes can be collected 515 from a plurality of candidates for the open position. Resumes can be collected 515 from any of a variety of sources as described above. A candidate profile can be generated 520 for each candidate based on the collected resumes. Generally speaking, the candidate profiles can comprise a more standardized and formalized, i.e., normalized, representation of the information presented in each received resume. Generation 520 of the candidate profiles can be performed in any of a variety of different ways as known in the art.

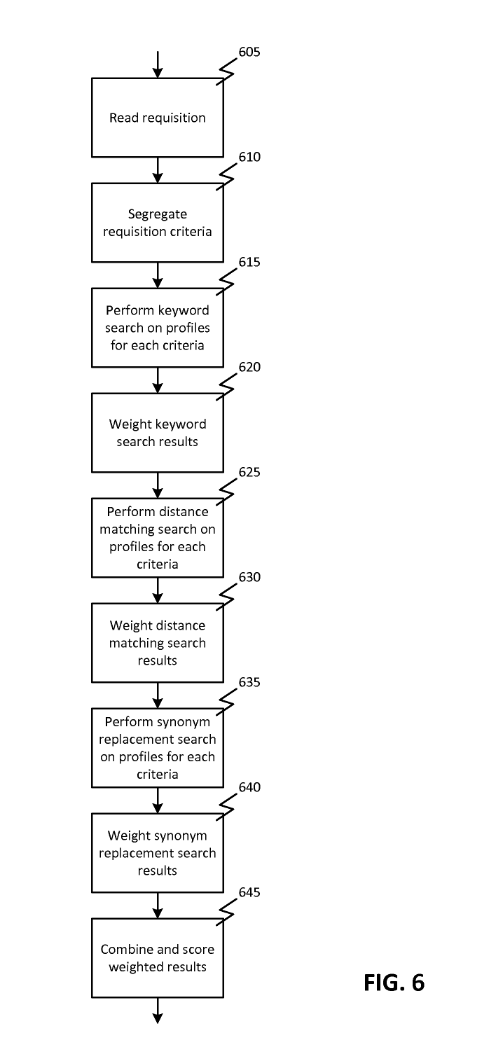

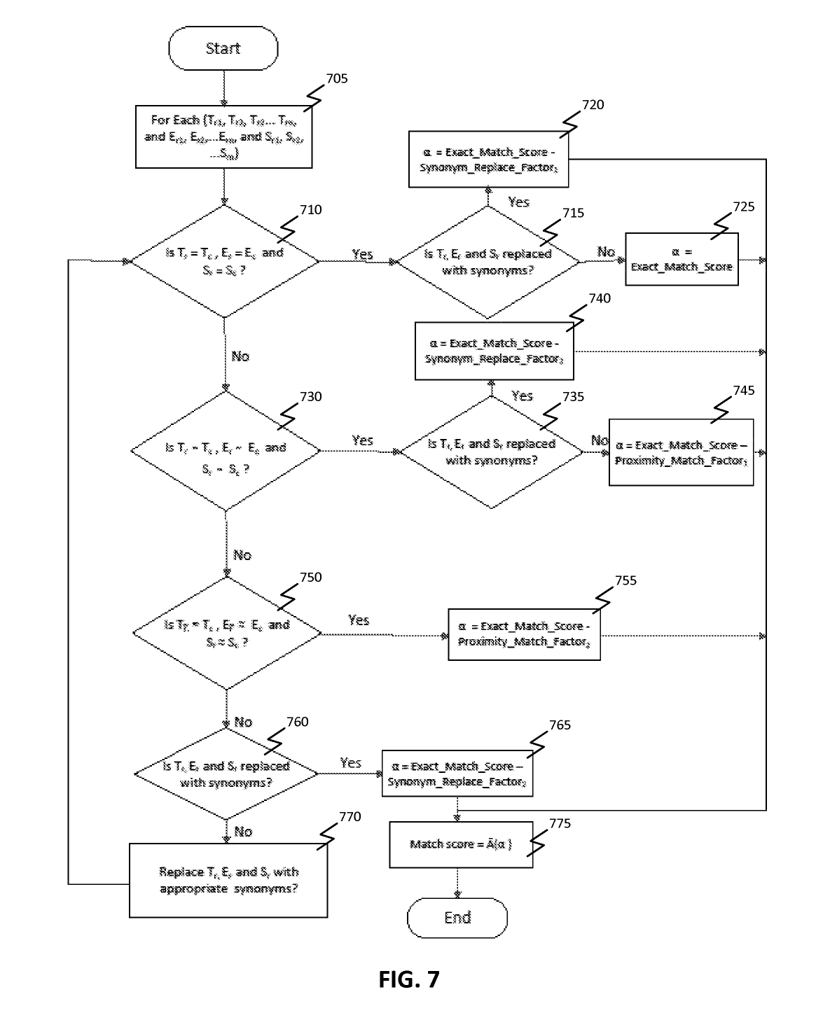

After a set of resumes has been collected 515 and a corresponding set of candidate profile has been generated 520, a search can be performed 525 on the generated candidate profiles using the generated requisition. Details of exemplary searches will be described further below with reference to FIGS. 6 and 7. However generally speaking, performing 525 the search an include performing multiple different types of searches of the candidate profiles using the requirements expressed in the requisition. Results of these searches can be weighted and a ranked candidate list can then be generated 530 based on results of performing the search.

FIG. 6 is a flowchart illustrating an exemplary process for searching a set of candidate profiles using a requisition for an open position according to one embodiment of the present invention. As illustrated in this example, performing the search on the generated candidate profiles using the generated requisition can begin with reading from the requisition a plurality of requirements for the open position. As noted above, such requirements and other information can include but are not limited to a job title, educational requirements, skills required, etc. Each such requirement of the plurality of requirements can be segregated 510 or separated into a plurality of different search criteria. So for example, the plurality of different search criteria can comprise one or more job title criteria, one or more education criteria, and one or more skills criteria.

Once these separate search criteria are defined, the search can be performed on the generated candidate profiles. In one case, the search can include performing 615 a keyword search on the generated candidate profiles using the plurality of different search criteria. Results of performing 615 the keyword search can be weighted 620 based on the results and one or more weighting factors. Performing the search on the generated candidate profiles using the generated requisition can further comprise performing 625 a distance matching search on the generated candidate profiles using the plurality of different search criteria. Results of performing 625 the distance matching search can also be weighted 630 based on the results and one or more weighting factors. Performing the search on the generated candidate profiles using the generated requisition can further comprise performing 635 a synonym replacement search on the generated candidate profiles using the plurality of different search criteria. Performing 635 the synonym replacement search may comprise making appropriate synonym replacements and repeating the keyword search and distance matching search. Results of performing 635 the synonym replacement search can also be weighted 640 based on the results and one or more weighting factors. Additionally or alternatively, other searches may be performed and the results of those searches can also be weighted based on one or more weighting factors.

The weighted results of performing the keyword search, the weighted results of performing the synonym replacement search, the weighted results of performing the distance matching search, and the weighted results of any other searches performed can then be combined and scored 645. A ranking of the results in or the order of the ranked candidate list can be based on a score for the combined weighted results. As noted above, a weight applied to each of the results of performing the keyword search, the results of performing the synonym replacement search, and the results of performing the distance matching search can be definable or tunable by a user to influence the results in order to provide better matches. Additionally or alternatively, the ranking for each of plurality of candidates in the candidate list can be adjustable by a user.

FIG. 7 is a flowchart illustrating additional details of an exemplary process for searching a set of candidate profiles using a requisition for an open position according to one embodiment of the present invention. More specifically, this example illustrates an implementation of the keyword search, synonym replacement search and distance matching search outlined above. As illustrated here:
Tr=Requisition job title
Tc=Candidate job title
Er=Requisition education qualification
Ec=Candidate education qualification
Sr=Requisition skill set
Sc=Candidate skill set
˜=Smaller distance search
≈=longer distance search
α=Weightage
Ā(α)=Aggregate of weightage

In this example, searching 705 can be performed on candidate profile and for each criteria, e.g., job title, education qualification, and skillset. A determination 710 can be made as to whether the job title, education qualification, and skill set from the requisition each match the job title, education qualification, and skill set from the candidate profile. In response to determining 710 that all match, a further determination 715 can be made as to whether the match is based on any synonym substitution. In response to determining 715 the match is based on at least one synonym substitution, the weightage of the match can be set 720 to a predefined exact match score minus a predefined synonym replacement factor for the keyword search. In response to determining 715 the match is not based on a synonym substitution, the weightage of the match can be set 725 to the predefined exact match score.

In response to determining 710 that the job title, education qualification, and skill set from the requisition do not all match the job title, education qualification, and skill set from the candidate profile, a further determination 730 can be made as to whether the job title, education qualification, and skill set from the requisition comprise a near match the job title, education qualification, and skill set from the candidate profile based on a small distance search comparison. In response to determining 730 the job title, education qualification, and skill set from the requisition comprise a near match the job title, education qualification, and skill set from the candidate profile, a further determination 735 can be made as to whether the match is based on at least one synonym substitution. In response to determining 735 the match is based on at least one synonym substitution, the weightage of the match can be set 740 to a predefined exact match score minus a predefined synonym replacement factor for the distance match search. In response to determining 735 the match is not based on at least one synonym substitution, the weightage of the match can be set 745 to a predefined exact match score minus a predefined proximity match factor for the near match.

In response to determining 730 the job title, education qualification, and skill set from the requisition do not comprise a near match the job title, education qualification, and skill set from the candidate profile, a further determination 750 can be made as to whether the job title, education qualification, and skill set from the requisition comprise a farther match the job title, education qualification, and skill set from the candidate profile. That is, the permissible distance for the distance matching comparison can be increased. In response to determining 750 the job title, education qualification, and skill set from the requisition comprise a farther match the job title, education qualification, and skill set from the candidate profile, the weightage of the match can be set 755 to a predefined exact match score minus a predefined proximity match factor for the farther match.

In response to determining 750 the job title, education qualification, and skill set from the requisition comprise a farther match the job title, education qualification, and skill set from the candidate profile, a determination can be made as to whether any of the job title, education qualification, and skill set from the requisition. In response to determining 760 that each of the job title, education qualification, and skill set from the requisition have already been replaced with synonyms, the weightage of the match can be set 765 to a predefined exact match score minus a predefined synonym replacement factor for the distance match search. The match score for the search can be set 775 to the aggregate of the weightages of the matches. In response to determining 760 that each of the job title, education qualification, and skill set from the requisition have not yet been replaced with synonyms, synonym replacements can be made 770 and the keyword search 710-725 and distance match search 730-755 can be repeated.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums or memory devices, such as CD-ROMs or other type of optical disks, floppy diskettes, ROMs, RAMs, EPROMs, EEPROMs, magnetic or optical cards, flash memory, or other types of machine-readable mediums or memory devices suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for identifying candidates for an open position, the method comprising:
receiving a plurality of requirements for an open position;
generating a requisition for the open position based on the received plurality of requirements;
collecting resumes from a plurality of candidates for the open position;
generating a candidate profile for each candidate based on the collected resumes;
performing a search on the generated candidate profiles using the generated requisition; and
generating a ranked candidate list based on results of performing the search.

2. The method of claim 1, wherein performing the search on the generated candidate profiles using the generated requisition comprises:
reading from the requisition a plurality of requirements for the open position; and
segregating the plurality of requirements into a plurality of different search criteria.

3. The method of claim 2, wherein performing the search on the generated candidate profiles using the generated requisition further comprises:
performing a keyword search on the generated candidate profiles using the plurality of different search criteria; and
weighting results of performing the keyword search.

4. The method of claim 3, wherein performing the search on the generated candidate profiles using the generated requisition further comprises:
performing a synonym replacement search on the generated candidate profiles using the plurality of different search criteria; and
weighting results of performing the synonym replacement search.

5. The method of claim 4, wherein performing the search on the generated candidate profiles using the generated requisition further comprises:
performing a distance matching search on the generated candidate profiles using the plurality of different search criteria; and
weighting results of performing the distance matching search.

6. The method of claim 5, further comprising:
combining the weighted results of performing the keyword search, the weighted results of performing the synonym replacement search, and weighted results of performing the distance matching search; and
scoring the combined weighted results for the plurality of candidates, wherein a ranking in the ranked candidate list is based on a score for the combined weighted results.

7. The method of claim 6, wherein the plurality of different search criteria comprise one or more job title criteria, one or more education criteria, and one or more skills criteria.

8. The method of claim 6, wherein a weight applied to each of the results of performing the keyword search, the results of performing the synonym replacement search, and the results of performing the distance matching search are definable by a user.

9. The method of claim 6, wherein the ranking for each of plurality of candidates in the candidate list is adjustable by a user.

10. A system comprising:
a processor; and
a memory coupled with and readable by the memory and storing therein a set of instructions which, when executed by the processor, causes the processor to identify candidates for an open position by:
receiving a plurality of requirements for an open position,
generating a requisition for the open position based on the received plurality of requirements,
collecting resumes from a plurality of candidates for the open position,
generating a candidate profile for each candidate based on the collected resumes,
performing a search on the generated candidate profiles using the generated requisition, and
generating a ranked candidate list based on results of performing the search.

11. The system of claim 10, wherein performing the search on the generated candidate profiles using the generated requisition comprises:
reading from the requisition a plurality of requirements for the open position;
segregating the plurality of requirements into a plurality of different search criteria;
performing a keyword search on the generated candidate profiles using the plurality of different search criteria;
weighting results of performing the keyword search;
performing a synonym replacement search on the generated candidate profiles using the plurality of different search criteria;
weighting results of performing the synonym replacement search;
performing a distance matching search on the generated candidate profiles using the plurality of different search criteria; and
weighting results of performing the distance matching search.

12. The system of claim 11, further comprising:
combining the weighted results of performing the keyword search, the weighted results of performing the synonym replacement search, and weighted results of performing the distance matching search; and
scoring the combined weighted results for the plurality of candidates, wherein a ranking in the ranked candidate list is based on a score for the combined weighted results.

13. The system of claim 12, wherein the plurality of different search criteria comprise one or more job title criteria, one or more education criteria, and one or more skills criteria.

14. The system of claim 12, wherein a weight applied to each of the results of performing the keyword search, the results of performing the synonym replacement search, and the results of performing the distance matching search are definable by a user.

15. The system of claim 12, wherein the ranking for each of plurality of candidates in the candidate list is adjustable by a user.

16. A computer-readable memory comprising a set of instructions stored therein which, when executed by a processor, causes the processor to identify candidates for an open position by:
receiving a plurality of requirements for an open position,
generating a requisition for the open position based on the received plurality of requirements,
collecting resumes from a plurality of candidates for the open position,
generating a candidate profile for each candidate based on the collected resumes,
performing a search on the generated candidate profiles using the generated requisition, and
generating a ranked candidate list based on results of performing the search.

17. The computer-readable memory of claim 16, wherein performing the search on the generated candidate profiles using the generated requisition comprises:
reading from the requisition a plurality of requirements for the open position;
segregating the plurality of requirements into a plurality of different search criteria;
performing a keyword search on the generated candidate profiles using the plurality of different search criteria;
weighting results of performing the keyword search;
performing a synonym replacement search on the generated candidate profiles using the plurality of different search criteria;
weighting results of performing the synonym replacement search;
performing a distance matching search on the generated candidate profiles using the plurality of different search criteria;
weighting results of performing the distance matching search;
combining the weighted results of performing the keyword search, the weighted results of performing the synonym replacement search, and weighted results of performing the distance matching search; and
scoring the combined weighted results for the plurality of candidates, wherein a ranking in the ranked candidate list is based on a score for the combined weighted results.

18. The computer-readable memory of claim 17, wherein the plurality of different search criteria comprise one or more job title criteria, one or more education criteria, and one or more skills criteria.

19. The computer-readable memory of claim 17, wherein a weight applied to each of the results of performing the keyword search, the results of performing the synonym replacement search, and the results of performing the distance matching search are definable by a user.

20. The computer-readable memory of claim 17, wherein the ranking for each of plurality of candidates in the candidate list is adjustable by a user.
